(19) United States
(12) Patent Application Publication
(10) Pub. No.: US 2015/0039105 A1
(43) Pub. Date: Feb. 5, 2015

(54) HOME INTELLIGENCE SYSTEM AND METHOD

(71) Applicant: Wen-Sung Lee, Taichung City (TW)

(72) Inventor: Wen-Sung Lee, Taichung City (TW)

(21) Appl. No.: 13/956,364

(22) Filed: Aug. 1, 2013

(51) Int. Cl. G06N 5/04; G06N 99/00; H04L 12/28; G05B 15/02

(52) U.S. Cl. CPC G06N 5/04; G05B 15/02; G06N 99/005; H04L 12/2803; H04L 2012/285
USPC 700/90

(57) ABSTRACT

A home intelligence system and method for use in a house and interaction with appliances in the house. The system includes an identification sensor that is configured to detect presence of a home member and identify ID information of the home member. The system further includes a data logger that records the ID information from the identification sensor, a controller that detects control parameters of appliances adjusted by the home member and transmits the detected control parameters to the data logger, and a learning module that correlates the ID information with the detected control parameters to customize for the home member a set of preferred control parameters for operating the appliances. Upon the home member is detected, the controller retrieves from the learning module the set of preferred control parameters based on the ID information of the home member and directs the appliances to operate with the set of preferred control parameters.

### BACKGROUND OF THE INVENTION

1. Field of the Invention

The present invention relates to a home intelligence system, and more particularly to a home intelligence system that provides a customized home appliance control service for each of the home members, and to a method employing the home intelligence system.

2. Description of the Related Art

It is well known for homes to have sophisticated electronic automation systems, which may include electronic security and surveillance systems, systems for controlling and scheduling the operation of the home's HVAC system, a lawn sprinkler system, exterior and interior lighting, and so on. That is, home automation systems allow home members to automate and control the use of electrical products and appliances in and around the house, and create and launch house scenes, involving one or more products and appliances. Examples of specific products and appliances that can be automated and controlled are lights, television sets, sound systems, coffee machines, ovens, furnaces, air conditioners, water heaters, humidifiers and lawn sprinklers. By interconnecting various appliances or systems, operation of the residence can be handled in a more convenient and efficient manner.

Prior art automation systems for residences have typically been limited to a constant scheduling of the operation of the home appliances to comply with the needs of a whole family, and have not been smart enough to accommodate the special needs of each family member.

### SUMMARY OF THE INVENTION

To solve the problems mentioned above, it is an objective of the present invention to provide a relatively-smart home intelligence system to fulfill the special needs of each family member.

The home intelligence system, for use in a house and interaction with appliances in the house, includes an identification sensor, a real-time locating system and an artificial intelligence device. The identification sensor is configured to detect presence of a home member and identify ID information of the home member. The real-time locating system is provided to automatically identify and track location of the home member in real time within the house. The artificial intelligence device includes a data logger, a controller and a learning module. The data logger is provided to record the ID information of the home member from the identification sensor and further records location information of the home member from the real-time locating system. The controller is configured to detect control parameters of appliances switched or adjusted by the home member and transmits the detected control parameters to the data logger. The learning module is configured to correlate at least the ID information and the location information with the detected control parameters to customize for the home member a set of preferred control parameters for operating the appliances. Accordingly, upon the home member is detected with the ID information and the location information, the controller retrieves from the learning module the set of preferred control parameters based on the ID information and the location information and directs the appliances to operate with the set of preferred control parameters for the detected home member.

Another object in accordance with the present invention is the provision of a home intelligence method employing the home intelligence system above.

The home intelligence method includes the steps of (a). detecting, by an identification sensor, presence of a home member and identifying ID information of the home member; (b). detecting, by a controller, control parameters of appliances adjusted by the home member; (c). recording, by a data logger, the ID information of the home member from the identification sensor and the control parameters of the appliances from the controller; (d). correlating, by a learning module, at least the ID information with the detected control parameters from the data logger to customize for the home member a set of preferred control parameters for operating the appliances; and (e). upon the home member is detected within the house, the controller directing the appliances to operate with the set of preferred control parameters for the home member.

Preferably, the method further includes, before step (d), the steps of: identifying and tracking location of the home member in real time within the house by a locating system; and recording, by the data logger, location information of the home member from the locating system. In this manner, in step (d), the learning module correlates at least the ID information and the location information with the detected control parameters from the data logger to customize for the home member the set of preferred control parameters for operating the appliances.

Further benefits and advantages of the present invention will become apparent after a careful reading of the detailed description with appropriate reference to the accompanying drawings.

### BRIEF DESCRIPTION OF THE DRAWINGS

A home intelligence system and method according to the invention will now be described, by way of example, with reference to the accompanying drawings, in which:

FIG. 1 is a block diagram of the home intelligence system;

FIG. 2 illustrates an user interface of a controller of the home intelligence system interacts with home appliances;

FIG. 3 is a cross section of a house in which the home intelligence system is installed, showing two home members are located in the first and second floor rooms of the house respectively;

FIG. 4 is a cross section of the house shown of FIG. 3, except that the home member who was in the second floor room has moved to the first floor room;

FIG. 5 is a cross section of the house shown of FIG. 3, except that the first floor room is occupied by three home members; and

FIG. 6 is a flow chart of the home intelligence method.

### DETAILED DESCRIPTION OF EMBODIMENTS

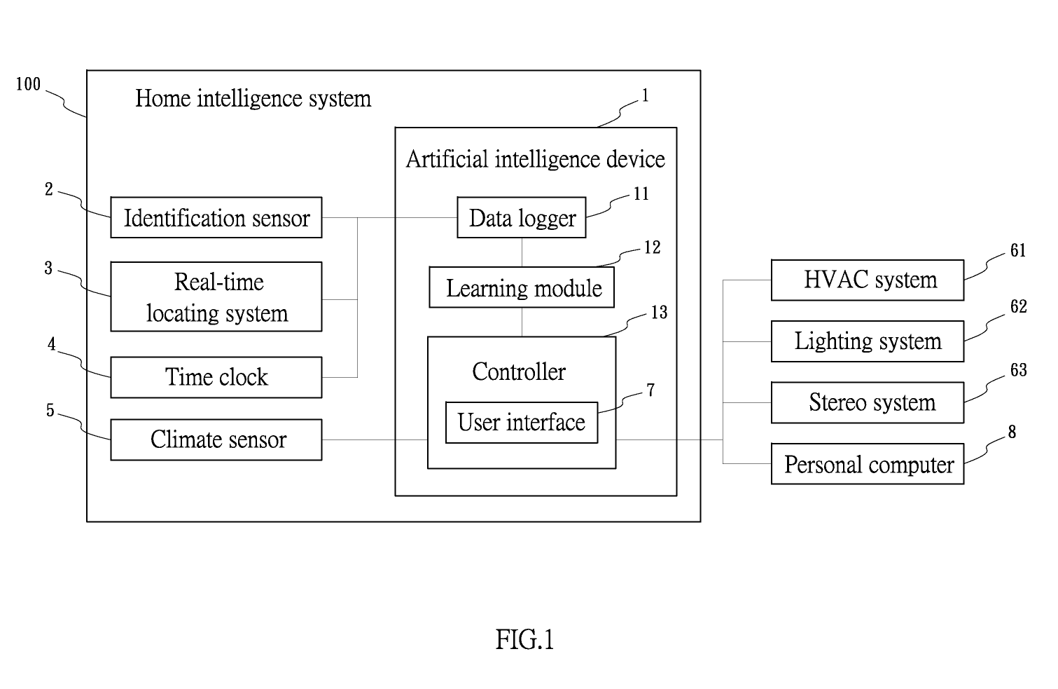

FIG. 1 illustrates a home intelligence system 100 for use in a house and interaction with appliances 61-63 in the house, which includes an artificial intelligence device 1 and at least an identification sensor 1

The artificial intelligence device 1 includes a data logger 11, a learning module 12 and a controller 13. The identification sensor 2 is configured to detect presence of a home member and identify ID information of the home member. The data logger 11 is configured to record the ID information of the home member from the identification sensor 2. The controller 13 is configured to detect control parameters of appliances 61-63 manually adjusted by the home member and transmit the detected control parameters to the data logger 11. The learning module 12 is configured to correlate at least the ID information with the detected control parameters to customize for the home member a set of preferred control parameters for operating the appliances 61-63.

Accordingly, upon the identification sensor 2 detects the presence of the home member with the ID information, the controller 13 retrieves from the learning module 12 the set of preferred control parameters based on the ID information and directs the appliances 61-63 to operate with the set of preferred control parameters for the detected home member. In other words, the home intelligence system 100 can identify each family member when he or she walks in the house and provide customized service for each family member.

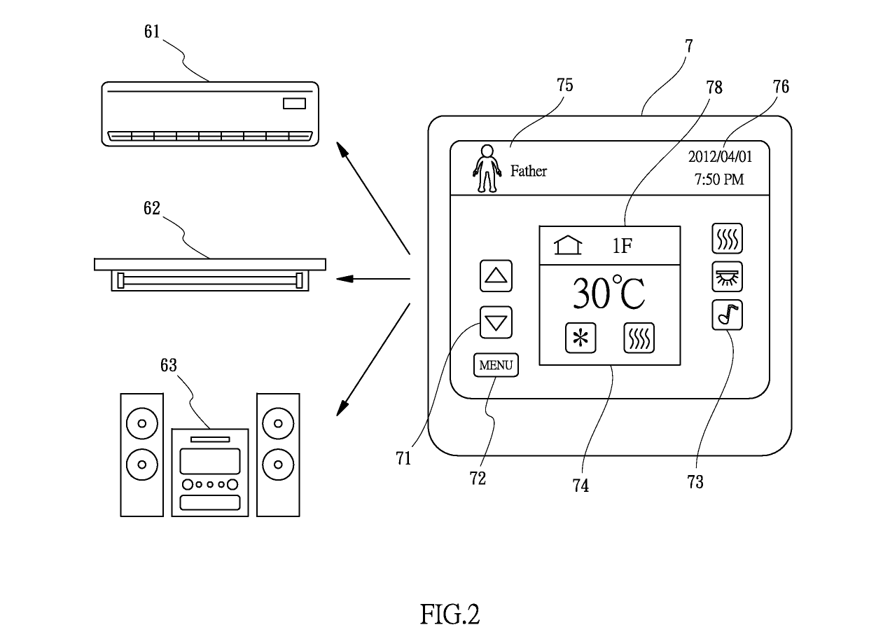

As shown in FIG. 1, a climate sensor 5 may be included and connected to the controller 13. The controller 13 may have a user interface 7 (see FIG. 2) to allow the home members to manually select or adjust control parameters for operating the appliances 61-63. Alternatively, a personal computer 8 (or a smart TV) may be provided and connected to the controller 13 such that the home members may actively interact with the personal computer 8 to adjust the parameters of the appliances 61-63 with or without the controller 13.

Preferably, a real-time locating system 3 is included in the home intelligence system 100 to automatically identifies and tracks location of the home member in real time within the house. In this case, the data logger 11 also records location information of the home member from the real-time locating system 3. The learning module 12 correlates at least the ID information and the location information with the detected control parameters to customize for the home member the set of preferred control parameters to operate the appliances 61-63, such that upon the home member is detected, the controller 13 retrieves from the learning module 13 the set of preferred control parameters based on the ID information and the location information of the home member and directs the appliances 61-63 to operate with the set of preferred control parameters for the detected home member.

More preferably, the home intelligence system 100 may further includes a time clock 4 to record time. In this case, the data logger 11 further records time information retrieved from the time clock. And, the learning module 12 correlates at least the ID information, the location information and the time information with the detected control parameters to customize for the home member the set of preferred control parameters for operating the appliances 61-63, such that upon the home member is detected, the controller 13 retrieves from the learning module 12 the set of preferred control parameters based on the ID information and the location information of the home member as well as the time information and directs the appliances 61-63 to operate with the set of preferred control parameters for the detected home member.

Referring to FIG. 2, the user interface 7 of the controller 13 is able to indicate the ID information 75, the time information 76, the location information 78 in real time, and climate information 74 from the climate sensor 5. Moreover, the user interface 7 also provides functional buttons 71, 72, 73, for a user to manually adjust the control parameters of the appliances 61-63. As such, operation of the appliances 61-63 can be handled in a more convenient and efficient manner.

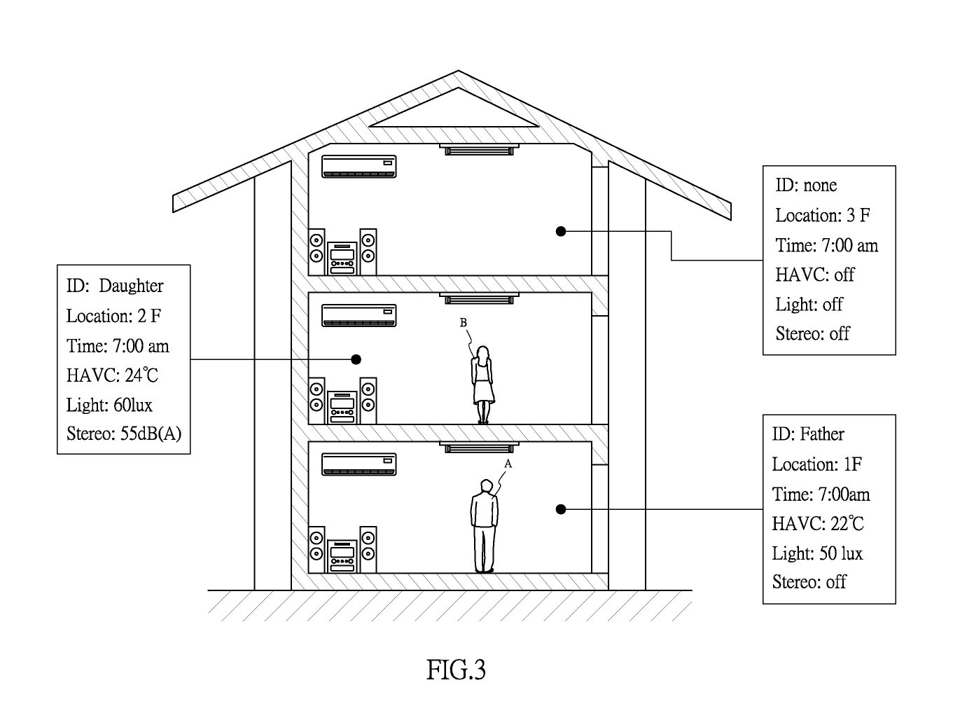

In practice, as shown in FIG. 3 for instance, a family member (A) enters in the first floor room, and therefore the identification sensor 2 detects the presence of the family member (A) and identifies, by the profile of the family member for example, that the family member (A) is a father with ID information (father), the real-time locating system 3 automatically identifies and tracks location of the father in real time within the house. The identification sensor 2, the real-time locating system 3 and the time clock 4 then transmit the ID information, the location information and the time information to the data logger 11. The data logger 11 receives and records the father's ID information from the identification sensor 2, the location information from the real-time locating system 3 and the time information from the time clock 4.

For any reason, the father then utilizes the user interface 7 or the computer 8 to adjust the temperature of the HVAC system 61 to be 22° C., the lighting system 62 to provide an illuminance of 50 lux, and the stereo system 63 to be off. At this time, the controller 13 detects the control parameters of appliances 61-63 adjusted by the father and transmit the detected control parameters to the data logger 11. The learning module 12 then correlates the ID information (father), the location information (1st floor room), and the time information (7:00 am) with the detected control parameters to customize for the home member a set of preferred control parameters for operating the appliances 61-63. In this way, next time the father comes in the first floor room again, the father will be detected by the home intelligence system 100 and the system 100 will automatically directs the HVAC system 61 to work on 22° C., the lighting system 62 to provide an illuminance of 50 lux, and the stereo system 63 to be off. In this case, the learning module 12 selects, among different previously used control parameters, a set of most recently used control parameters as the set of preferred control parameters for the home member. However, in other examples, the learning module 12 may select a set of his or her most frequently used control parameters as the set of preferred control parameters for the home member.

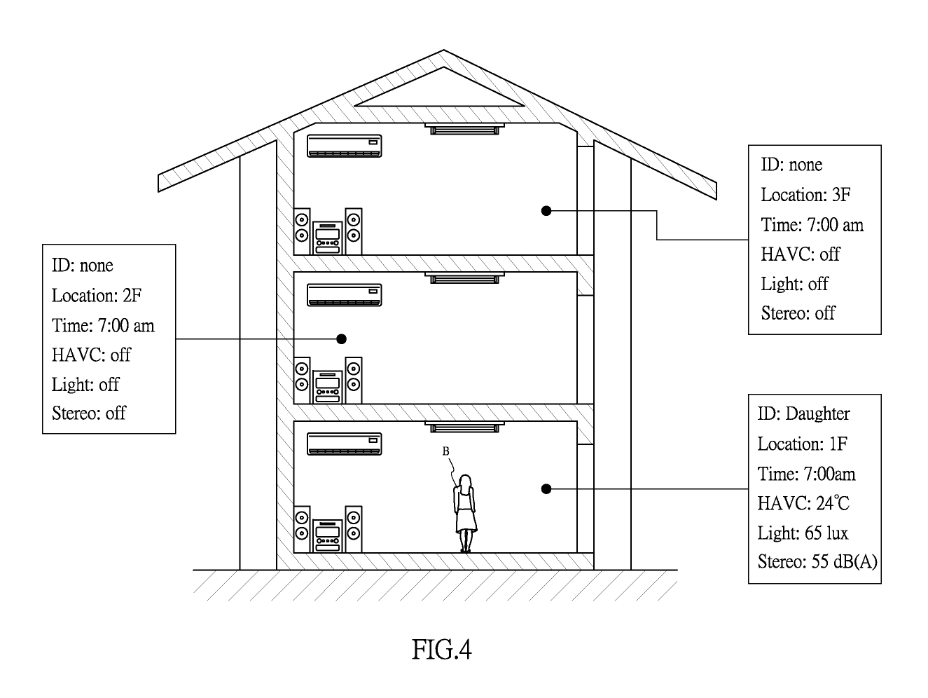

Referring to FIG. 4, on another day another family member (B) comes in the same first floor room. The identification sensor 2 detects the presence of the family member (B) and identifies that the family member (B) is a daughter with ID information (daughter), the real-time locating system 3 automatically identifies and tracks location of the daughter in real time within the house. The identification sensor 2, the real-time locating system 3 and the time clock 4 then transmit the ID information, the location information of the daughter and the time information to the data logger 11. The data logger 11, on the other hand, receives and records the daughter's ID information and location information and the time information for identification of the controller 13. Since the learning module 12 has previously customized a set of the daughter's preferred control parameters for operation of the appliances 61-63, the controller 13 then retrieves from the learning module 12 the set of the daughter's preferred control parameters to direct the appliances 61-63 to operate with preferred control parameters. In this example, when the daughter walks in the first floor room at 7:00 am, the home intelligence system 100 automatically set the temperature HVAC system is to be 24° C., turn on the lighting system 62 to provide an illuminance of 50 lux, and turn on the stereo system 63 to have the volume of 55 dB (A).

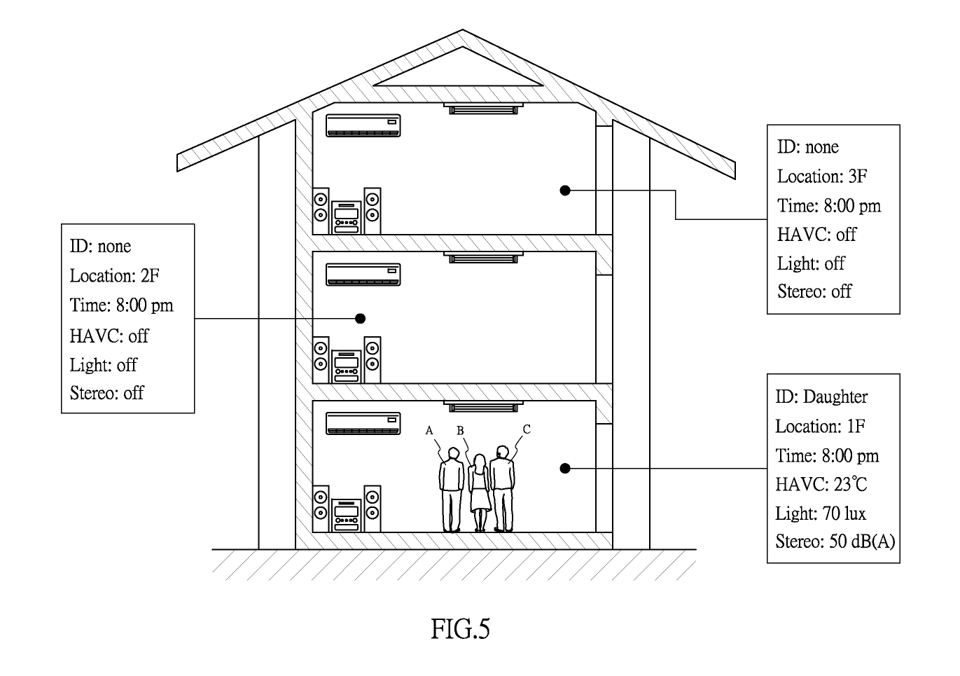

In the case where more than two family members are located in the same room, as shown in FIG. 5, the home intelligence system 100 provides the customized service only for the family member who has priority over the rest of the family members, such as the daughter in this example. Specifically, the data logger 11 is previously stored with a priority list to rank all home members (such as daughter, father, son, and so on). Upon two or more of the home members are detected in the same area within the house, the controller 13 determines which home member has priority over the other according to the priority list stored in the data logger 11 and retrieves the set of preferred control parameters based on the ID information, the location information and the time information of the priority home member and directs the appliances 61-63 to operate with the set of preferred control parameters for the priority home member. As show in FIG. 5, since the daughter (B) has priority over the father (A) and the son (C), the home intelligence system 100 will automatically direct the appliances 61-63 to operate with a set of daughter's preferred control parameters for the daughter. It is understood that the same family member may have different sets of preferred control parameters due to the difference of the location and/or the time. For example, compared to FIGS. 4 and 5, the daughter, which was in the same first floor room, but has the two different sets of preferred control parameters because the time changes, one in the morning while the other in the evening.

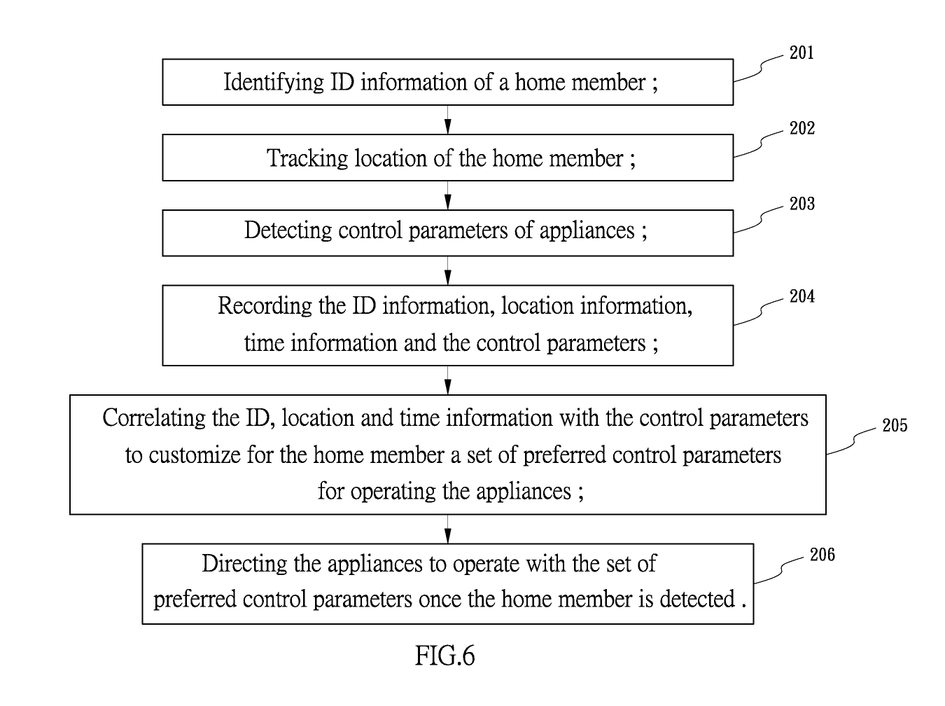

With reference to FIG. 6, a home intelligence method is provided according to the present invention. The home intelligence method employs the aforementioned system 100 and comprises the steps as follows:

In step 201, the identification sensor (2) detects presence of a home member and identifies ID information of the home member. In step 202, the real-time locating system 3 identifies and tracking location of the home member in real time within the house. In step 203, the controller 13 detects control parameters of appliances 61-63 adjusted by the home member. In step 204, the data logger 11 records the ID information of the home member from the identification sensor 2, the location information from the real-time locating system 3 and time information from the time clock 4 as well as the control parameters of the appliances 61-63 from the controller 13. In step 205, the learning module 12 then correlates at least the ID information, the location information and the time information with the detected control parameters from the data logger to customize for the home member a set of preferred control parameters for operating the appliances 61-63. In step 206, upon the home member is detected within the house, the controller directs the appliances 61-63 to operate with the set of preferred control parameters for the detected home member.

In step 205, in order to customize for the home member a set of preferred control parameters for operating the appliances, the learning module 3 may select, among different used control parameters, a set of most frequently used control parameters as the set of preferred control parameters for the home member. Alternatively, the learning module 12 may select a set of most recently used control parameters as the set of preferred control parameters for the home member.

Preferably, before step 206, the method may further comprises the steps of storing, by the data logger 11, a priority list to rank all home members. Thus, in step 206, upon two or more of the home members are detected in the same area within the house, the controller 13 will determine which one of the home members has priority over the other according to the priority list stored in the data logger 11 and retrieves from the learning module 12 the set of preferred control parameters based on the ID information and the location information of the priority home member and the time information and directs the appliances 61-63 to operate with the set of preferred control parameters for the priority home member.

It is to be understood that the disclosed embodiments are illustrative in nature and the invention is not to be limited to any one or more embodiments except as set forth in the following claims.

What is claimed is:

1. A home intelligence system for use in a house and interaction with appliances in the house, the system comprising:
an identification sensor that detects presence of a home member and identifies ID information of the home member; and
an artificial intelligence device including a data logger that records the ID information of the home member from the identification sensor, a controller that detects control parameters of appliances switched or adjusted by the home member and transmits the detected control parameters to the data logger, and a learning module that correlates at least the ID information with the detected control parameters to customize for the home member a set of preferred control parameters for operating the appliances such that upon the identification sensor detects the presence of the home member with the ID information, the controller retrieves from the learning module the set of preferred control parameters based on the ID information and directs the appliances to operate with the set of preferred control parameters for the detected home member.

2. The home intelligence system of claim 1, further comprising a real-time locating system that automatically identifies and tracks location of the home member in real time within the house, wherein the data logger further records location information of the home member from, the real-time locating system; the learning module correlates at least the ID information and the location information with the detected control parameters to customize for the home member the set of preferred control parameters to operate the appliances, such that upon the home member is detected, the controller retrieves from the learning module the set of preferred control parameters based on the ID information and the location information of the home member and directs the appliances to operate with the set of preferred control parameters for the detected home member.

3. The home intelligence system of claim 2, further comprising a time clock, wherein the data logger further records time information retrieved from the time clock; the learning module correlates at least the ID information, the location information and the time information with the detected control parameters to customize for the home member the set of preferred control parameters for operating the appliances, such that upon the home member is detected, the controller retrieves from the learning module the set of preferred control parameters based on the ID information and the location information of the home member as well as the time information and directs the appliances to operate with the set of preferred control parameters for the detected home member.

4. The home intelligence system of claim 2, wherein the data logger further is stored with a priority list to rank all home members; and upon two or more of the home members are detected in the same area within the house, the controller determines which home member has priority over the other according to the priority list stored in the data logger and retrieves the set of preferred control parameters based on the ID information and the location information of the priority home member and directs the appliances to operate with the set of preferred control parameters for the priority home member.

5. The home intelligence system of claim 1, wherein to customize for the home member the set of preferred control parameters for operating the appliances, the learning module selects, among different used control parameters, a set of most frequently used control parameters as the set of preferred control parameters for the home member.

6. The home intelligence system of claim 1, wherein to customize for the home member the set of preferred control parameters for operating the appliances, the learning module selects, among different used control parameters, a set of most recently used control parameters as the set of preferred control parameters for the home member.

7. The home intelligence system of claim 1, wherein the controller includes a user interface to allow the home members to manually select or adjust control parameters for operating the appliances.

8. A home intelligence method, comprising the steps of:
(a). detecting, by an identification sensor, presence of a home member and identifying ID information of the home member;
(b). detecting, by a controller, control parameters of appliances adjusted by the home member;
(c). recording, by a data logger, the ID information of the home member from the identification sensor and the control parameters of the appliances from the controller;
(d). correlating, by a learning module, at least the ID information with the detected control parameters from the data logger to customize for the home member a set of preferred control parameters for operating the appliances; and
(e). upon the home member is detected within the house, the controller directing the appliances to operate with the set of preferred control parameters for the detected home member.

9. The home intelligence method of claim 8, further comprising: before step (d), the steps of:
identifying and tracking location of the home member in real time within the house by a locating system; and
recording, by the data logger, location information of the home member from the locating system;
wherein in step (d): the learning module correlating at least the ID information and the location information with the detected control parameters from the data logger to customize for the home member the set of preferred control parameters for operating the appliances.

10. The home intelligence method of claim 9, further comprising: before step (d), the step of:
recording, by the data logger, time information from a time clock;
wherein in step (d): the learning module correlating at least the ID information, the location information and the time information with the detected control parameters from the data logger to customize for the home member the set of preferred control parameters for operating the appliances.

11. The home intelligence method of claim 8, wherein to customize for the home member the set of preferred control parameters for operating the appliances, the learning module selects, among different used control parameters, a set of most frequently used control parameters as the set of preferred control parameters for the detected home member.

12. The home intelligence method of claim 8, wherein to customize for the home member the set of preferred control parameters for operating the appliances, the learning module selects, among different used control parameters, a set of most recently used control parameters as the set of preferred control parameters for the detected home member.

13. The home intelligence method of claim 9, further comprising before step (e), the step of:
storing, by the data logger, a priority list to rank all home members;
wherein in step (e): upon two or more of the home members are detected in the same area within the house, the controller determines which home member has priority over the other according to the priority list stored in the data logger and retrieves the set of preferred control parameters based on the ID information and the location information of the priority home member and directs the appliances to operate with the set of preferred control parameters for the priority home member.
